(19) United States
(12) Patent Application Publication
(10) Pub. No.: US 2009/0100439 A1
(43) Pub. Date: Apr. 16, 2009

(54) INFORMATION ENGINE

(76) Inventor: Donald H. McNeil, Wyalusing, PA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/250,251

(22) Filed: Oct. 13, 2008

Related U.S. Application Data
(60) Provisional application No. 60/979,420, filed on Oct. 12, 2007.

(51) Int. Cl. G06F 9/54

(52) U.S. Cl. 719/313

(57) ABSTRACT

A user-customizable computer information engine called “windBreak” includes modular, autonomous, separately programmable, processing mytes which interact via the exchange of messages. It is equipped with user interface image protocols suitable for 2D and 3D presentations. Rather than appearing in predefined “windows,” mytes' images are presented in indefinitely large territories. Applications are derived from combinations of mytes, their data, their procedures, and their images, thus partaking of all of the facilities of the information engine and therefore fully integral and consistent with it as regards user interface conventions, application appearance, data management, and internal protocols. A myte is assigned to control every unitary process and to hold every unitary set of data, thus allowing for amorphous associative data management and fully scalable processing for implementations of any size. Mytes are addressable individually by name or associatively by the resultants of their internal processing and data.

### PRIORITY STATEMENT

This application claims priority under 35 U.S.C. §119 to U.S. Provisional Patent Application No. 60/979,420, entitled “Information Engine”, filed Oct. 12, 2007, which is hereby incorporated by reference in its entirety.

### FIELD OF THE INVENTION

The present invention relates to the field of computer operating environment software for end-user digital information management. More specifically, the present invention relates to application support and usage facilities provided as consistent with and integral to an operating environment. The present invention modifies and extends the concept of “object-oriented programming” to implement one active myte for each separable entity and to provide myte-oriented data and display images in an information engine which derives its operating system, application, and user interface functionality from a single metaphor: active mytes with their internal data, their internal procedures, and their images. An operating configuration of mytes and facilities for message exchange among them is herein called “windBreak.”

### BACKGROUND OF THE INVENTION

Early operating systems for digital computers served primarily to provide input/output access and to control the flow of batches of stand-alone programs submitted in bulk for compilation and execution. Subsequent generations of operating systems provided for multiple tasks within one computer and for real-time interactions between programs and on-line users. During that same period, computer hardware became very compact while CPU speeds and storage space increased dramatically. User interaction progressed from line-wise interactions via commands from teletype terminals to textual displays on CRTs and then to graphic user interfaces using “windowed” presentations of the images associated with separate applications, “tasks” or programs. Multiprogramming effectively separated the operations of different programs from the constraints of one CPU while windowing effectively separated the presentation area for an application from the constraints of the physical screen of the display unit. Multiprogramming schemes based upon tasks and threads have continued to prevail despite their relatively rigid pre-structuring; and the “windowed desktop” metaphor with predefined menus and tool palettes has continued to prevail despite its inherent limitations and relatively inflexible display format. Application programs for word processing, graphics, charting, modeling, spreadsheets, simulation, data analysis and presentation, etc., tend to be force-fit into windowed formats as separate utility-like programs. Meanwhile, where “object oriented programming” is employed, logical objects bear no necessary relation to tasks or to windows, leading to a hodge-podge of different combinations of these three concepts. All this has led to a plethora of different ways to perform similar tasks, overlapping functionalities, duplication of efforts, idiosyncratic user interfaces, inconsistencies in operability, and incompatibilities among applications and vendors. Sometimes a suite of programs (such as Microsoft Office) is patched together out of disparate applications and fitted with a language facility (such as Visual Basic) for manipulating them, but this “horizontal integration” is clearly an afterthought and an artifice. Application programs for graphics and 3D usually provide integrated facilities, including ways of arranging and grouping images, but typically do not treat their objects as active agents and are integrated only within themselves. “Browser” programs with “markup” languages were originally conceived as alternatives to operating systems but have reverted to being merely another specialized kind of application. Meanwhile, “authoring environments” with integrated languages and programming tools (such as Hypercard or Toolbook) have failed to develop their potentials and remain in limited use. The “open doc” standard which was proposed in the 1990s to supplant the traditional “program-centered” operating systems with a “document-centered” approach never got beyond the prototype stage. “Object-oriented” programming techniques, e.g., related to “Smalltalk” dialects, have remained abstruse and intractable for ordinary users, even where their features are widely distributed as in Microsoft Visual Basic. Most recently, the file-centricity of windowed operating systems established during the last two decades has tended to revert to the application-centricity of earlier computers, so nowadays a user is presented with a hodge-podge of specialized utility programs for burning CDs, listening to music, searching the web, exchanging email, taking notes, etc., rather than with a unified, consistent, and coherent facility. This retrogression only increases the tendency for end users to have to access their data through relatively inflexible programs and interfaces predetermined for them by programmers. Further limitations are imposed by the conventional requirements that data be rigidly structured in predefined ways, i.e., in files of records, in spreadsheets as arrays, in documents of pages, in stacks of cards, etc.

The present invention addresses many of the shortcomings of the end user interfaces, information management, data organization, and data processing for computing equipment of all sizes and deployments by constructing all operating environmental and application facilities out of mytes with their respective data, procedures, and images. Each myte is a logically autonomous unit of processing complete with an internal procedure and embedded data. Images associated with mytes do not appear in predefined windows, though they may optionally be grouped where need be, e.g., for presentation as pages of a document. Every image is associated with an active myte and the data it controls. The resulting information engine is inherently integrated because everything it does—including program processing and data management and display presentation—is derived from the unitary concept of the modular, active, autonomous myte which interacts with other mytes through a message protocol. For example, a segment of textual data embedded in a myte may be used as a note, a callout, a form field, a spreadsheet cell or a field of a data base record, but in any case it is under program control and able to send, receive, and respond to messages from other mytes of any kind. Data kept with mytes can be amorphous, not required to adhere to any formal structure such as in conventional files or data bases, but accessible nonetheless by name, by inspection of mytes' images, by search criteria relative to its data or resultants or images, and by its membership in one or more composite mytes. Moreover, mytes performing processes and representing data operate logically as fully concurrent activities and may be distributed across a plurality of computers in a completely consistent fashion using their message exchange protocol.

As will be demonstrated below, it is the object of the present invention to provide an integrated operating environment based upon a plurality of autonomous concurrent active software mytes, each of which contains embedded data and procedures and can process, store, and display data in such a way as to supplant the application programs, the file structures, and the visual presentations of conventional software operating systems. In this invention, applications are comprised of composites of one or more mytes which act in concert via the exchange of messages and whose images are displayed together to compose an end user interface. Since all applications are comprised of the same elements (mytes with their data, procedures, and images) and follow the same protocols, they present a coherent means of implementation to software developers and a consistent manner of use for end users. In general, mytes can be dedicated to highly resolved portions of larger tasks down to the level of a single elementary transformation. In particular, mytes may be standardized for particular application tasks such as text editing and graphics handling.

A second object of the present invention is to provide an integrated and thoroughly consistent end user interface, comprised of myte's images separately or in composites on behalf of particular applications. The requirements for strictly formatted windows and rigidly structured files are thus obviated.

A third object of the present invention is to provide for the storage, search, and processing of amorphous data. Mytes can be dedicated to highly resolved items of data down to the level of a single stored byte. Because mytes act in parallel, a broadcast message can set all (or a selection of) mytes to work in searching or transforming their data concurrently, thus having the effect of associative memory and processing, including “search-by-result” and “search-by-image.”

A further object of the present invention is to provide a fully scalable operating environment which can be used on computing equipment of any size or configuration, whether it be small or large, monolithic or distributed.

Yet another object of the present invention is to provide an orderly migration from conventional applications and data by placing mytes in a hypervisory role so as to emulate legacy operating systems in parallel under windBreak, or alternatively to provide windBreak as an application under a conventional operating system.

One or more of these and/or other objects, features, or advantages of the present invention will become apparent from the specifications and claims that follow.

### BRIEF SUMMARY OF THE INVENTION

The windBreak information engine provides a user-customizable software interface for gathering, storing, organizing, transforming, and presenting data. It is suitable for use as a self-contained application under an existing operating system or to supplant other operating systems. Conceptually, it turns conventional information management approaches inside-out, centering its activity on autonomous operating mytes rather than upon files, documents, programs, abstract “objects,” utilities or whole computers. A windBreak operating environment as a control program is not divided into “jobs” or “objects” or “windows” or “tasks” or “applications” but rather is built up out of one or more self-contained mytes which comprise the units of operation and of data storage and algorithm which communicate with one another by sending and receiving messages. Mytes may be grouped into composite mytes in which all of the associated mytes work together as if they were a single myte. Mytes grouped into composite mytes may be treated as documents or files or applications; any myte may belong to more than one composite myte, and mytes may be embedded within other mytes to any degree of nesting. Mytes may reside in one physical computer or in multiple physical computers. The presentation of a myte upon a display is called its image. A myte may present itself via different images at different times or in different situations. The images of mytes may consist of text, graphics or pictures, any of which may be edited with tools built into windBreak or provided by the functionality of other mytes. In general, the image of a myte may be anything representable upon a display, including text, 2D graphics, 3D graphics, animations, etc. The image of a composite myte includes the images of all the mytes which it contains. At any given time, a myte's image as a whole may be visible or invisible. Mytes are displayed in territories. A territory is an indefinitely large area suitable for display as a whole or in part upon a computer screen, together with the images of the mytes which it contains. A territory is two dimensional for 2D implementations and three dimensional for 3D implementations, the latter providing for a three dimensional operating environment and for 3D applications. A territory may be navigated, panned, scrolled, and zoomed to focus upon, view, and manipulate mytes and their images in the territory. There is one all-encompassing territory for a given windBreak installation as a whole, and a territory is associated with each individual myte and composite myte. Every myte has procedures which determine its activities as a process and its presentation as an image. Access to windBreak is provided in the context of a profile which is a composite myte describing the user and containing the mytes which he may utilize. When a user signs on to windBreak, he effectively jumps into a composite myte which allows him to work only with mytes and images in its territory, i.e., as determined by his profile and made accessible via his personal identification and password.

According to one aspect of the present invention, an information engine is provided. The information engine includes a plurality of concurrently active mytes stored in a computer readable memory and interacting through exchange of messages. Each of the plurality of concurrently active mytes includes: (a) an input message receiver; (b) an output message sender; (c) a processing element in operative communication with the receiver and the sender; (d) a data element; (e) a plurality of properties associated with the processing element to include a procedure (program); and (f) a representation of a visual image. Each of the plurality of concurrently active mytes is addressable by name or by data content or by resultant or by image.

According to another aspect of the present invention, a method of providing an information engine includes providing a plurality of active mytes stored in computer readable memory, the plurality of active mytes interacting through exchange of messages, and wherein each of the plurality of mytes comprises (a) an input message receiver, (b) an output message sender, (c) a processing element in operative communication with the receiver and the sender, (d) a data element, (e) a plurality of properties associated with the processing element to include a procedure (program), and (f) a representation of a visual image.

### BRIEF DESCRIPTION OF THE DRAWINGS

FIG. 1 is a block diagram of one embodiment of a myte.

FIG. 2 is a pictorial representation of several different specialized mytes.

FIG. 3 is a pictorial representation of several intercommunicating mytes.

FIG. 4 is a pictorial representation of several mytes with a search criterion.

FIG. 5 is a pictorial representation of several composite mytes.

FIG. 6 is a pictorial representation of several mytes in a 2D territory.

FIG. 7 is a pictorial representation of several mytes in a 3D territory.

### DETAILED DESCRIPTION OF THE PREFERRED EMBODIMENT

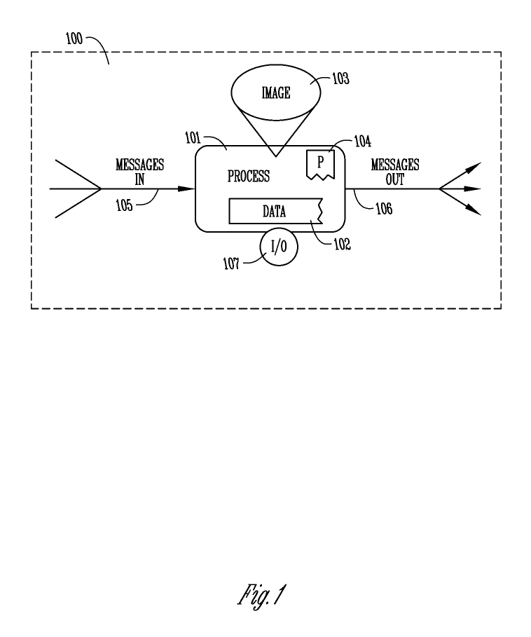

The present invention as a whole is referred to as windBreak. Information management is performed in windBreak by a one or more of autonomous mytes communicating through messages, optionally grouped into composites. Mytes may reside in one physical computer or in multiple physical computers. In FIG. 1 a myte 100 is composed of at least an input 105 to receive messages from other mytes; a processing element 101 to transform data; and an output 106 from which messages are sent to other mytes; a storage for the data 102 associated with the myte, an image 103 for representing the myte in a territory on a display, a list of properties 104 which describe, parameterize, and program the myte, and an (optional) I/O interface 107 which connects the myte directly to a physical I/O device. Throughout windBreak, each myte 100 is addressed by name (or accession number) or by the content of its data 102 or by the result of its processing 101.

Every myte presents itself with an image 103 on a display, e.g., a computer screen. This image may be as simple or as complex as required by the work which the myte performs. An image may be made visible or invisible as need be. (Images are described in some detail in the User Interface section below.) Images are presented in territories. A territory is associated with each individual myte and with each composite myte.

In operation, a myte runs a procedure which is specified as one of its properties 104. When a message is received, the processing element of the myte performs the action(s) specified by the message as conditioned by the myte's properties, including its procedure. This processing may produce zero or more messages which are sent to other mytes. Where an (optional) I/O device is attached, processing may also exchange data directly with the I/O interface. The procedure property of a myte is used to program a myte to respond to one or more different kinds of messages distinguished by their operation codes. (The programming language which a myte can interpret is determined by the particular implementation. In general, one or more languages may be interpreted by an individual myte, and different mytes may interpret different languages.)

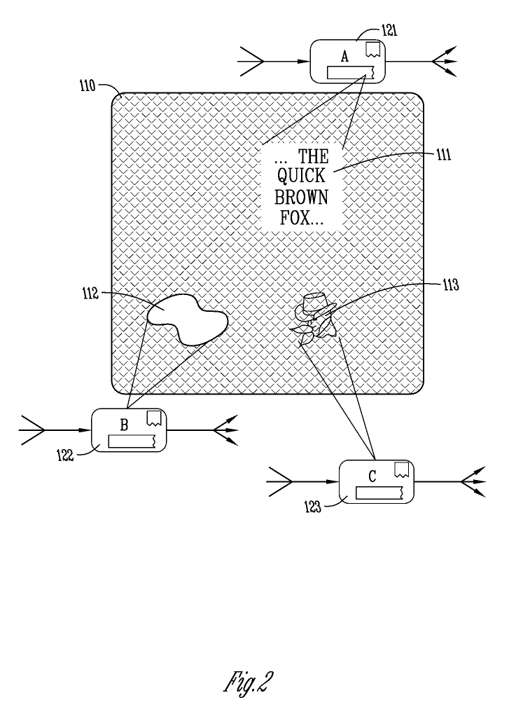

In FIG. 2, several individual mytes 121, 122, and 123 are shown relative to a display 110. Myte A 121 is managing text 111, e.g., as a “word processor” or portion thereof; Myte B 122 is managing a graphic 112; and Myte C 123 is managing a picture 113. Whole displays of data are thus composed from the images such as 111, 112, and 113 associated with their respective mytes.

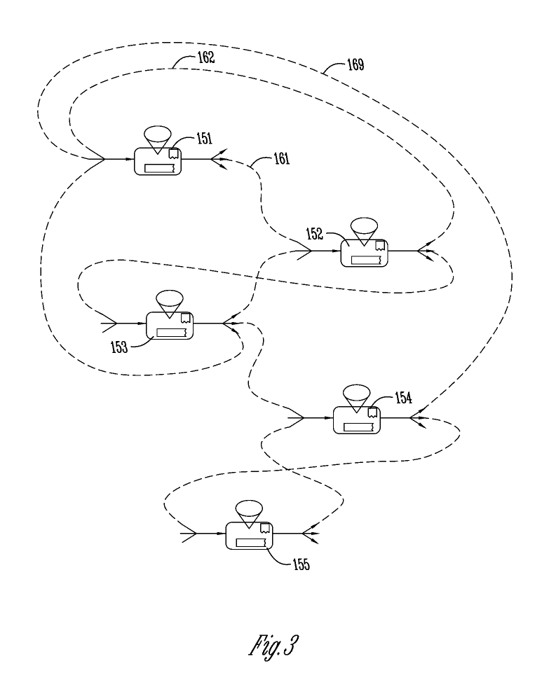

A message is comprised of at least a source and a destination indicating the sending and receiving mytes, a date and time stamp indicating when the message was sent, an operation code which indicates what the message is about, and a list of zero or more data parameters which are to be used in conjunction with the operation code. Data elements may contain bytes of data to be taken literally or may refer to mytes from which data is to be requested through subsequent exchanges of messages. In a typical exchange, one myte sends a message to another and the receiving myte processes the message, then replies to the sender with a message indicating what action has been taken based on the first message. In FIG. 3, a myte 151 sends a message 161 to another myte 152 and receives a confirmatory message 162 back. Then, after a series of message interactions among mytes, the first myte 151 receives a message 169 back from another myte 154.

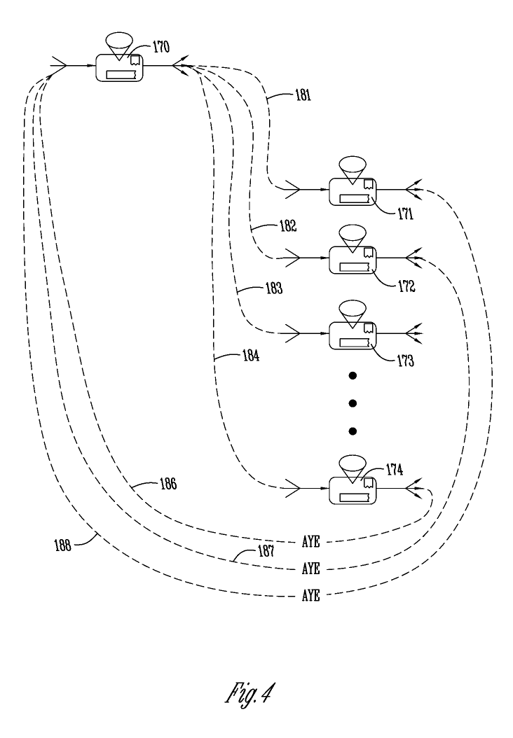

Every myte has storage for the data 102 it holds and manages. Data may consist of a character string of zero or more bytes or may have any format or structure whatsoever, e.g., to define text, a graphic representation, a file or a data base. Every unitary set of data, however large or small, has an active processing myte dedicated to it. From outside a myte, its data can only be accessed by the exchange of messages or the (optional) I/O interface under control of the myte's processing. This myte can send messages in the event, e.g., that the data contains a particular search parameter or has been changed to a particular value. Data in windBreak is amorphous in the sense that every accessible datum is addressed by name or by resultant via its myte. For example, in FIG. 4 a myte 170 broadcasts messages 181, 182, 183, and 184 to other mytes 171, 172, 173, and 174 asking whether the resultant of their respective procedures matches a criterion specified in the messages, and zero or more mytes may respond aye, e.g., mytes 171, 172, and 174 with messages 186, 187, and 188 in this example.

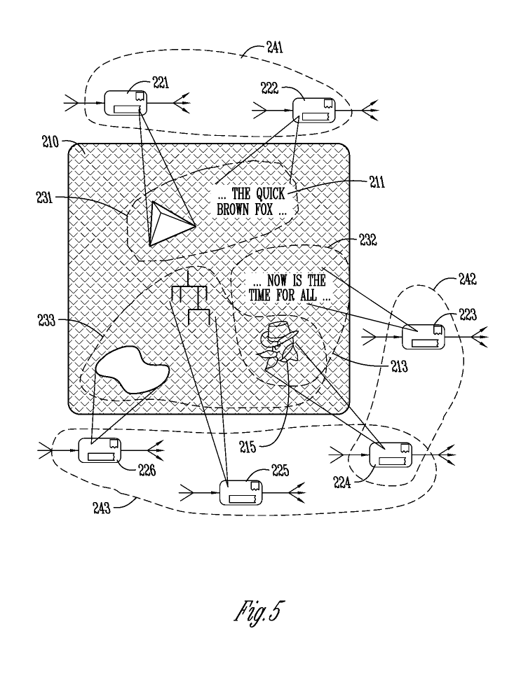

Mytes may be grouped into composite mytes in which several mytes are grouped together as if they were a single myte. The image of a composite myte includes the images of all of its subordinate mytes. Every composite myte maintains a “directory” property which lists all of the mytes in it. Composite mytes may be grouped, thus allowing for hierarchies of nested mytes to any depth. Composite mytes are not exclusive, i.e., any myte may belong to more than one composite myte. A composite myte may be ungrouped to separate its subordinate mytes. (All properties assigned to a composite myte as a whole are discarded if it is ungrouped.) In FIG. 5, mytes 221, 222, 223, 224, 225, and 226 present their respective images upon a display 210. Mytes 221 and 222 are grouped as a composite myte 241 with a composite image 231. Mytes 223 and 224 are grouped as a composite myte 242 with a composite image 232. Mytes 224, 225, and 226 are grouped as a composite myte 243 with a composite image 233. Myte 224 with its image 215 belongs to two composites, i.e., 242 and 243.

A myte may serve as a connector to associate two or more other mytes. Connectors may be used to associate mytes which reside on different physical computers, e.g., as hyperlinks to various websites. The image of a connector myte may appear as line routed between the images of other mytes or may be invisible.

Every myte has properties which determine its activities as a process, its presentation as an image, and other relevant characteristics. System-defined properties of every myte include at least its unique accession number, its creation timestamp, and its update timestamp. User-changeable properties of a myte include at least its name, caption, owner, password, visibility of its image, nominal dimensions of its image, current dimensions of its image, its image location within its territory, its earmark (selection indicator), and codes for tooltips, highlighting, dimming, and user-defined properties. A “procedure” property provides algorithms for the myte's processing.

Every myte behaves as a programmable process having an active functional repertoire with which to respond to messages which it receives, data which it manages, and images which it presents. Procedures associated with a myte are specified in its “procedure” property. A procedure is specified as a sequence of programmatic operations or algorithms to be performed by a myte when a message is received by that myte. Every process for every myte within an implementation runs logically in parallel with the processing done by every other myte, i.e., in a radically-concurrent, autonomous, asynchronous, poly-processing manner. A myte's current procedure may be synchronized with those of one or more other mytes as need be, e.g., by waiting for a message from one of them before it proceeds. Each myte is a self-contained unit of processing and data which interacts with other mytes only through messages, so the programming within a myte may be in any computer language, depending upon the particular implementation of windBreak, but that language must at least accommodate a message recognition apparatus which accepts messages from its input, performs its functions based upon the content of those messages, and sends output messages. The procedure for a myte consists of one or more conditional clauses, each specifying the process to be performed for a different operation code in a received message. If there is no process for a given message specified in the myte to which that message is directed, the message is passed along to the next superordinate composite myte and so forth. Messages may be generated by operations of the windBreak implementation itself, e.g., when a myte's image is selected for editing or when a myte is deleted or when a control tool button is clicked by a user or when the system is idle; messages may concern data situations, e.g., upon a data event when a datum or a resultant in one myte changes so as to meet a given criterion; messages may concern timing events, e.g., when a particular time of day on a particular date becomes current or when a preset time interval expires; and messages may be formulated specifically by a user or a myte and sent to any myte which has been programmed to receive it. Messages are typically addressed to particular mytes, but when appropriate a message may be broadcast to all mytes or to a subset thereof. Messages sent to unavailable or non-responding mytes may be handled by an exception processing myte, as may be any messages which indicate error conditions.

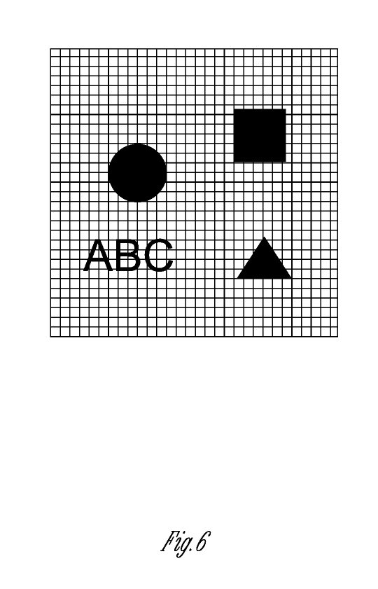

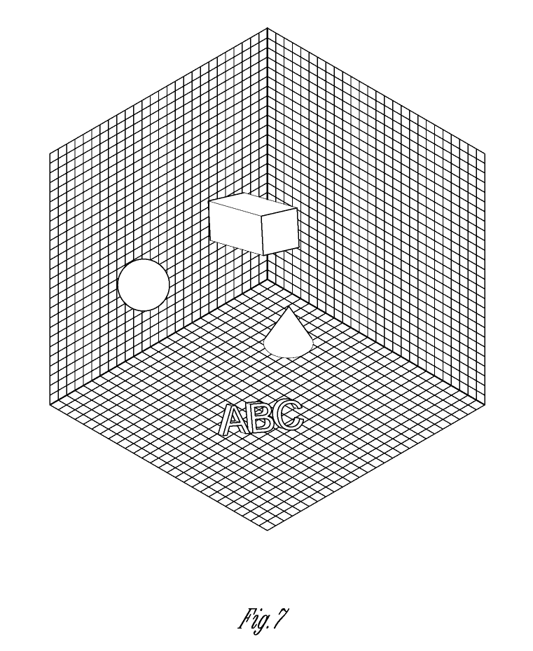

Images of mytes are presented in territories. A territory is associated with each individual myte and with each composite myte. Control options which may be provided by tool palettes, menus, commands or other include at least the ability to navigate within the current territory and to create mytes and composite mytes as well as to cut, copy, paste, duplicate, delete, find, and edit mytes. A log is kept of all changes made; multiple levels of undo and redo controls are provided for reversing any changes which have been made within a logging interval. Reviewing back and forth among previous views of territories and navigating next and previous among mytes in the current context are also provided. A territory may have width and height in a 2D implementation of windBreak as suggested in FIG. 6 or it may have width, height, and depth as suggested in FIG. 7. A context is the aggregate of mytes and their images which are directly accessible at any one time, i.e., the mytes in the territory of the current composite myte. Jumping into a composite myte narrows the context to the territory of that composite myte; jumping out of a composite myte expands the context to include all mytes in the territory of the superordinate myte. The context of a windBreak installation as a whole is the broadest and includes all of the mytes and their territories as subordinates.

A foreign program is defined to be a program written for an operating system or environment other than windBreak e.g., for Microsoft Windows, Mac OS, Unix, etc. Where windBreak runs under one of those host operating systems, a myte may launch a foreign program, sending data arguments to it and receiving results from it to the extent allowed by the foreign program. If the foreign program is made so as to send or to receive windBreak messages, communication between windBreak and the foreign program may take place; alternatively, the foreign program may operate independently in its own window(s) of the host operating system as if windBreak were not present. Where windBreak is itself the host operating system, it may (in particular implementations) provide an environment which emulates the one for which the foreign program was written and present that program's user interface so as to simulate windowing and other conventional features.

A remote myte is defined to be a physically separate computer or operating system with which windBreak is electronically and logically connected. Where a particular interconnection of facilities allows windBreak messages to be communicated among different machines and/or operating systems which are running remotely and concurrently, messages sent and received by processes in their respective environments operate in the same fashion as those exchanged in an entirely local facility, and the physical separation of facilities is not apparent to operations of the system as a whole. This consistency and concurrency also applies where a single facility has multiple physical computing elements operating in parallel, e.g., under a “multiprocessor” scheme.

A prefabricated myte is one which has been supplied with the implementation or provided by a third party to perform a particular function. The functionality of a prefabricated myte may be as simple as a calculator or as complex as a chess-playing program. For purposes of usability and standardization, prefabricated mytes for word processing, graphics processing, picture presentation, audio, and video would typically be supplied. Also, I/O drivers would typically be provided as prefabricated mytes also.

A particular implementation of windBreak may include a selection of the following system-defined mytes. The data embedded in these mytes may include lists, queues, directories, etc., as need be. The images of these mytes may be invisible or (optionally) may be formatted and positioned to suit a particular end user.

| | |
|---|---|
| supervisor | monitors system and distributes messages among mytes |
| imaging | manages image I/O for mytes |
| manipulation | creates, groups, deletes, cuts, copies, pastes, etc., mytes |
| status | reports system conditions as a whole |
| directory | displays and updates the directories of composite mytes |
| tools | manages text, graphics, painting, etc. |
| timing | manages clock, calendar, timing, and scheduling |
| search | initiates a search of myte's data, resultants, or images |
| earmarks | manages list of earmarked mytes |
| history | manages list of mytes' images visited |
| log | manages list of actions performed |
| excerpts | manages list of images copied out of mytes by a user |
| profile | manages list of authorized users and their preferences |
| exception | manages error conditions |
| launch | manages interfacing with foreign programs |
| driver | at least one manages each physical I/O device |

### User Interface:

The user-customizable software interface of windBreak presents the image of at least one myte (elsewhere described). An image may be a display of text, hypertext, graphics, pictures, 3D graphics, animations, or any other representation whatsoever, e.g., as suggested by FIG. 5. The image is changed and/or manipulated under control of the myte it represents. An image may be read-only or can be subject to alteration by a user. For example, an image may consist of alphanumeric text which a user may edit under control of the image's myte. Similarly, an image may consist of graphic figures which can be drawn and altered by a user. Alternatively an image may display options, e.g., as a menu or palette or tool bar, and its myte may redirect activities depending upon which option a user selects. In a two dimensional implementation, all images are 2D unless a myte makes a 3D presentation of itself, in a three dimensional implementation, all images are 3D, though they may be viewed frontally as 2D.

Mytes are created using system control messages or by drawing them using an appropriate tool, e.g., text tool, graphic tool, painting tool. Composite mytes are created by earmarking one or more mytes' images and grouping them using a system control tool. Composite mytes may be grouped as well as mytes, thus allowing for hierarchies of nested mytes to any depth. Mytes' images may be cut, copied or pasted, and may be dragged into or out of composite mytes by manipulating their images. Navigation among mytes may be done by direct selection, by command message, by name via a directory, by relative position (next/previous), and by order of access (back/forth). A composite myte may be manipulated directly as it stands among other mytes in the territory using system controls. Alternatively, a user may jump in to a composite myte, whereupon only the images of the mytes within the territory of that composite myte are visible and accessible until jumping out to the superordinate context. Composite mytes are not exclusive, i.e., a myte may belong to more than one composite myte. A composite myte may be ungrouped by earmarking it and using a system control to ungroup its component mytes. (All properties assigned to a composite myte as a whole are discarded if it is ungrouped.) Undo and redo facilities are provided for all manipulations of mytes.

A myte may serve as a connector to associate two or more other mytes. Optionally, it may visibly trace a formatted line from one myte's image to another myte's image. (Visible connectors may appear as straight lines or may contain angles and curves, depending upon the application and the implementation.) Connectors may be used to associate mytes which reside on different physical computers, e.g., as hyperlinks to various websites.

Segments of text within a myte's image may be selected, e.g., by click-dragging over them. They can then be reformatted, copied, or replaced as need be, as in any word processor. Mytes may be embedded in the text of a myte's image as embedded subordinates. Embedded subordinates may appear within text as text segments or as embedded graphics or pictures, depending upon their contents. They may be used as form fields for data entry or presentation, as spreadsheet fields, as illustrations, etc. They may appear in-line with text, between lines of text or wrapped by text. Embedded subordinates may include mytes having text in their images, which in turn may contain subordinates, nested to any desired level.

A composite myte may be used as a template for multiple replications of itself having different content in its mytes' images. An array of replications of a composite myte can serve as a data base file where each replication of the composite myte plays the role of a data base “record” and each myte's image plays the role of a data base “field.” In a procedure, numerical subscripts may be used to refer directly to particular items of an array, and content searches may be used to select array items also. (If an array item is empty, references to it yield null results.)

User access to windBreak is provided in the context of a profile which is a composite myte describing the user and the mytes which he may utilize. When a user signs on to windBreak, he effectively jumps into a composite myte which allows him to work only in that context which is determined by his profile and made accessible via his personal identification and password.

### Applications

The windBreak information engine can be used directly as an information management facility for taking notes, sketching, keeping a data repository, and for browsing and searching amorphous data wherever mytes having the appropriate functionality are available. Mytes can be programmed to support an authoring, application development, and operational environment. With further customization using prefabricated mytes, it can also serve as any of the following:
Generalized information engine where mytes' images are used to capture notes, sketches, pictures, etc., and connectors provide links to references, and all these are organized into composite mytes subject to searching in parallel by broadcast messages of inquiry;
Word processor where mytes' images play the role of documents and subordinate mytes play the role of embedded pictures, callouts, notations, etc.;
Graphics program where mytes whose images display graphics, pictures, and text are used together to present graphical layouts;
Scheduler where mytes representing tasks send messages to one another and to a user interface myte for notification of events and initiation of predefined actions;
Data base manager where composite mytes play the role of files, subordinate composite mytes play the role of records, and mytes' images play the role of data base fields, with data searching being conducted in parallel by mytes in response to broadcast messages containing lookup criteria;
Data entry manager where composite mytes play the role of forms and separate or embedded images of mytes play the roles of data entry fields and descriptive data;
Spread sheet or table where composite mytes play the role of sheets, arrays of myte's images play the role of table fields, and mytes' procedures play the role of spreadsheet commands;
Chart manager where myte's images together with connectors among them play the roles of chart blocks and chart block connectors;
Simulator where mytes running concurrently are programmed to act as the functional blocks and connectors of a general purpose simulation with messages exchanged between mytes to establish connectivity among blocks;
Web browser where the programming language of an implementation of windBreak includes a standard markup language as a subset and connectors provide hyperlinks;
Desktop interface where composite mytes and composites of composite mytes play the role of files and folders and where nested composite mytes serve as hierarchies of these;
Windowing manager where composite mytes are assigned opaque backgrounds and elaborated borders so as to appear and function as conventional “windows.”
Shared worksite in which several people can work simultaneously via a local network or the internet by sharing and exchanging mytes and their messages.
Hypervisor under which various operating systems can run as the programs in mytes.
Video game engine where mytes and their images correspond to animations and their parts.

Some of the features of windBreak which are unique individually and in combinations can be identified as follows:
1. Composition of applications using highly resolved autonomous mytes which are always “open” and active;
2. Composition of visual interface from the images generated by one or more mytes;
3. Composition of documents, files, and data bases from the data held by one or more mytes;
4. Inherent radical concurrency of processing down to the myte level, including multiprocessing on different physical machines;
5. Uniform use of mytes throughout the operating environment and applications;
6. Uniform treatment of all mytes and images with their properties and data down to the level of individual mytes;
7. Uniform way of grouping mytes into composite mytes with hierarchical nesting and embedding, and with options to jump in and out of their contexts;
8. Uniform messaging protocol for coordinating the activities of local and remote mytes;
9. Mytes as the managers of highly resolved modules of data;
10. Support for amorphous data and presentations thereof;
11. Support for multiprogramming and multiprocessing in any combination;
12. Scalable for use in implementations of any size;
13. Suitable for local and remote parallel operations;
14. Uniform look and feel for all data preparation, presentation, and processing;
15. Fully customizable appearances, interfaces, and data representations;
16. Suitable for use with 2D and 3D presentations;
17. Uniform presentations and controls down to the myte level;
18. Uniform provisions for managing connectors between mytes and their images;
19. Uniform text handling wherever text appears, e.g., in myte's images and in properties;
20. Uniform method of earmarking of selected mytes and of data within mytes;
21. Uniform integral programming, e.g., in a markup language;
22. Uniform undo/redo for all changes and updates system wide.

### Survey:

Clearly, it would be possible to use windBreak mytes as ordinary highly structured tasks whose images were presented as if in windows and which operate as conventional applications, e.g., as word processors, graphics programs, etc. As a practical matter, this approach allows windBreak to support legacy applications from other operating systems such as those commonly in use today. The intended deployment of windBreak mytes and their images is, however, in highly resolved, modular, distributed, parallel, amorphous, free form, protean, and ad hoc applications where data structures are not rigidly predefined, search criteria may vary in unpredictable ways, and information presentation needs to be customized to particular users and altered for different situations. Applications of this kind include note taking, the gathering and organizing of research data, the operation of creative enterprises, and the management of idiosyncratic information. There are some facilities which are commonly needed such as text editing, graphical drawing, and management of pictures and audio, so a practical implementation of windBreak would typically provide general purpose mytes for each of these. Prefabricated and standardized composites of mytes which act as templates for organizing data as files of records and/or for presentations such as spreadsheets can be provided as well, and other conventional applications can be constructed as composites also. Libraries of algorithms which can be used in common by a plurality of mytes can be supplied for practicality and standardization. The merits of the windBreak approach are most relevant where its support for amorphous data and presentations thereof makes possible the management of large numbers of data fragments which need to be manipulated, organized, searched, recalled, reorganized, earmarked, processed, and presented.
Other features may include:
   integration is derived from central metaphor of the active autonomous myte-with-data-and-image
   mytes are always active (no files or applications to “open”)
   operating environment and applications are comprised of mytes and composites of mytes
   operating system is directly usable as an information management engine
   operating system is inherently scalable for implementations of any size or dispersal
   uniform generalized messaging among local and remote mytes with inherent concurrency
   inherent ability to signal programmatic and data events via messages
   uniform suites of properties for mytes, including procedure property for programming
   uniform treatment of mytes and composite mytes
   a myte may be part of more than one composite myte
   myte images may appear as parts of bigger pictures
   each image or part thereof is generated by the ongoing activities of a myte
   reliability inherent in using the same mechanisms for all common functionalities
   each module of data is active under control of a myte
   support for amorphous data and various organizations and presentations thereof
   support for data events and resultant events
   support for parallel concurrent searches of data, resultants, and images
   uniform means of searching data, resultants, and images
   uniform and consistent user interface presentation of mytes' images
   uniform presentation and handling of text, graphics, etc., in images
   fully customizable user interface with user-defined presentations
   uniform composites with subordinate and superordinate contexts
   suitable for 3D as well as 2D presentations
   suitable for multiprogramming or multiprocessing or any combination
   suitable for local or remote parallelism, i.e. concurrency of operations
   uniform navigation among mytes and their images, e.g. back/forth, next/previous
   mytes as uniform connectors among other mytes and to external data
   uniform generalized change logging with undo/redo
   uniform universal earmarking of selected mytes
   uniform handling of text data via common library algorithms
   uniform integral programming in markup language (vs. stand-alone applications)
   unload/load myte properties and data
   import/export myte data from/to conventional files
   copy/cut/paste among myte images and to host OS

All mytes are logically open and active at all times. In any particular application, only a subset of mytes would require physical resources at any point in time. The logical myte provides for a unit of virtualization and caching as well as for memory and CPU usage.

Thus, an information engine and various aspects and methods associated with an information engine have been disclosed. The present invention is not to be limited to the specific disclosure herein as the present invention contemplates numerous variations, options, and alternatives apparent to one skilled in the art and having the benefit of this disclosure.

1. An information engine, comprising:
a plurality of concurrently active mytes stored in a computer readable memory and interacting through exchange of messages;
each of the plurality of concurrently active mytes comprising:
(a) an input message receiver;
(b) an output message sender;
(c) a processing element under control of a procedure property in operative communication with the receiver and the sender;
(d) a data element;
(e) a plurality of properties associated with the processing element;
(f) a representation of a visual image;
wherein each of the plurality of concurrently active mytes is addressable by name, or by data content, or by resultant, or by image.

2. The information engine of claim 1 wherein the processing element of a first of the plurality of mytes provides for transformation of data obtained from a second of the plurality of mytes.

3. The information engine of claim 1 wherein each of the messages comprises a source, a destination, a time sent field, an operation code, and parametric data.

4. The information engine of claim 1 wherein the plurality of properties include system-defined properties and user changeable properties.

5. The information engine of claim 1 wherein the plurality of concurrently active mytes form a file or document.

6. The information engine of claim 1 wherein the plurality of concurrently active mytes form an application.

7. The information engine of claim 1 wherein the plurality of concurrently active mytes form an operating environment.

8. The information engine of claim 1 wherein the plurality of concurrently active mytes are distributed across multiple processors.

9. The information engine of claim 1 wherein the plurality of concurrently active mytes are distributed across multiple computers.

10. The information engine of claim 1 wherein at least one of the plurality of mytes is a composite myte comprised of multiple mytes.

11. The information engine of claim 1 wherein the mytes being configured to detect and respond to data events.

12. The information engine of claim 1 wherein the mytes and their images being configured to occupy virtual territories in two dimensions or in three dimensions.

13. The information engine of claim 1 wherein the mytes provide for units of virtualization of physical resources.

14. A method of providing an information engine, comprising:
providing a plurality of active mytes stored in computer readable memory, the plurality of active mytes interacting through exchange of messages, and wherein each of the plurality of mytes comprises (a) an input message receiver, (b) an output message sender, (c) a processing element under control of a procedure property in operative communication with the receiver and the sender, (d) a data element, (e) a plurality of properties associated with the processing element, and (f) a representation of a visual image.

15. The method of claim 14 wherein the plurality of active mytes form at least one of a file, a document, an application, an operating environment, and a composite myte.

16. The method of claim 14 further comprising performing a search to find data within the plurality of active mytes.

17. The method of claim 14 further comprising performing a search to find an image within the plurality of mytes.

18. The method of claim 14 further comprising performing a search to find a resultant associated with one or more of the plurality of mytes.

19. The method of claim 14 further comprising performing a search to find data content associated with one or more of the plurality of mytes.
